(19) United States
(12) Patent Application Publication
(10) Pub. No.: US 2006/0242578 A1
(43) Pub. Date: Oct. 26, 2006

(54) Method for managing content

(75) Inventors: Ate Sander Van Steenbergen, Groningen (NL); Bob Richard De Vries, Haren (NL); Reanne Martine Van Der Velde, Groningen (NL); Réné Banus, Groningen (NL)

Correspondence Address: MICHAELSON & ASSOCIATES, P.O. BOX 8489, RED BANK, NJ, 07701, US

(73) Assignee: KONINKLIJKE KPN N.V., Groningen (NL)

(21) Appl. No.: 10/560,952

(22) PCT Filed: Jun. 25, 2004
(86) PCT No.: PCT/EP04/06974

§ 371 Date: Jun. 5, 2006

Related U.S. Application Data
(60) Provisional application No. 60/483,481, filed on Jun. 27, 2003.
(60) Provisional application No. 60/483,808, filed on Jun. 30, 2003.

(51) Int. Cl. G06F 3/00

(52) U.S. Cl. 715/700

(57) ABSTRACT

A method is disclosed for editing by a user (1) of content (2) which content is to be represented via an end-user device to an end-user. According to this method, a translation function (3) is used that translates content (2) into production content (4). The translation function (3) makes use of characteristics of end-user device types, so that the resulting production content (4) is suitable for being presented via end-user devices without the user (1) having to take care of the different characteristics of the different end-user device types. It is also disclosed that content is processed for preview purposes by a processing function (5) that makes use of characteristics of end-user device types resulting in preview content (6) that can be presented to the user (1) and which preview content (6) is representative for how the production content (4) would be presented to an end-user via an end user device.

### FIELD OF THE INVENTION

The present invention relates to a method for managing content that is accessible via communication devices.

### BACKGROUND OF THE INVENTION

It has become increasingly important for consumers and business users to use web based applications and services which are accessible via the Internet or any other type of web based or IP based network. As a consequence, web content and—services, as well as the lay-out of the content and services is modified frequently to keep it actual and accurate. This means that service and content providers put a lot of effort in this process of keeping content and services up to date. Content managers, web developers, webmasters at Internet Service Providers (ISP's), e-commerce companies, content providers and other (regular) businesses are involved in this process.

Another development relates to the method for accessing web based content and services. There is a tendency that the usage of mobile devices becomes increasingly popular. There are many different types of mobile devices such as mobile phones, PDA's, and laptops that are configured for wireless communication. These types of devices comprise a screen on which content can be shown and via which services can be accessed. The differences between these types of devices can be regarding several hardware, firmware and software related aspects. This can be the case for the communication means, the processing means, and the input/output means that are part of this devices. Relating to the communication means there are many different protocols that are available such as GSM, GPRS, UMTS, W-LAN, DECT and BlueTooth. Also relating to the input/output means such as the screen and the keyboard of mobile devices there are many different possibilities. Among other things, input/output means can differ in size, quality and functionality.

To make it possible to keep web based service and content up to date there are content management systems available. With these content management systems it is possible perform editorial activities in an edit environment. In this edit or development environment it is possible to modify and update content and services without making these modifications available to end-users. In U.S. Pat. No. 6,505,212 is such a method disclosed for website development. However, a disadvantage associated with known website development environments is that no account is taken to the different types of end-user devices that are used to access the content and the services. The editor should as a consequence edit and maintain different versions of the content or services in order to accomplish that the content and the services will be presented to the end-user in an appropriate way.

Aim of the Invention

It is an object of the invention to eliminate the drawbacks of the prior art and to provide an efficient concept for managing content and services accessible via communication devices, taking into account characteristics of end-user devices.

### SUMMARY OF THE INVENTION

In accordance with this invention a method is disclosed for editing content, the method according to the present invention comprises:

Editing by a user of content to be represented via an end-user device to an end-user, using a translation function that translates content into production content which translation function makes use of characteristics of an end-user device type, resulting in production content that is suitable for being presented via an end-user device of said type.

In a first aspect of the present invention a method is disclosed for converting content into production content by a translation function, while taking into account characteristics of devices. The devices can be communications devices such as mobile phones, laptops and PDA's. The invention is not limited to the management of content that is accessed using mobile devices. Also devices that are used to access content via a fixed network are within the scope of this invention. The content that is to be translated is digital content and can be any of content that can be presented to an end-user such as a website, images, video content, audio content, files, computer programs, and data. The content is meant to be presented by a device to the end-user of the device via the output facilities of the device such as a screen or a loud speaker. In the case that the characteristics, such as the size of the screen, of different device types are different the content will not be presented in a similar way to the user of the device. Therefore, the characteristics of end-user devices are taken into account when converting content into production content. The production content can be suitable for being sent to the end-user devices. For each end-user device type there could be a specific production content. In such a way it is not needed when editing to edit a separate content for each device type. Instead, the editor of the content has to edit just one version of the content, i.e. the content that will be converted by the translation function. In general, the characteristics of the devices are hardware, firmware or software related, or can be related to the users of the devices. In the latter in can for instance be that a specific group of end-users have special preferences in relation to the presentation of content. For instance visual disabled people may need a much larger size of symbols and letters on the screen. In this situation, these preference (as such or combined with the characteristics of the end-user devices) should be taken into account when generating the production content. By providing the translation function with parameters that represent the characteristics of the different end-user devices, the editor of the content should not be aware of the different characteristics of the different end-user devices. The editor can because of this work on one version of the content.

According to another aspect of the present invention the content can be previewed via a preview means available to the editor of the content before being sent to the end-user devices. The preview means are in general not of the same type as the end-user devices. For instance, the preview means is a personal computer with a relatively large screen while the end-user devices are mobile telephones. However, the editor of the content that previews the content desires to see the content in such a way that it corresponds to the content as it is presented to end-users. For instance, the actual size and the resolution of the screen of an end-user device should be taken into account when presenting content via the preview means to the editor of the content. For this purpose there is a processing function comprised by the preview means that processes the output of the translation function during or after converting content into the production content. The processing function takes into account the differences between the characteristics of the preview means and the characteristics of the different types of end-user devices. This is accomplished by providing parameters to the processing function representing characteristics of different types of end-user devices and characteristics of the preview means.

### BRIEF DESCRIPTION OF THE DRAWING FIGURE

The foregoing aspects and many of attendant advantages of this invention will become better understood by reference to the following detailed description, when taken in conjunction with the accompanying drawing, wherein:

FIG. 1 shows a block diagram illustrating the concept of editing and previewing content intended to be presented via different types of end-user devices.

FIG. 2 shows a block diagram illustrating an embodiment according to the concept depicted in FIG. 1.

### EXEMPLARY EMBODIMENTS

For the purpose of teaching of the invention, preferred embodiments of the method and devices of the invention are described in the sequel. It will be apparent to the person skilled in the art that other alternative and equivalent embodiments of the invention can be conceived and reduced to practice without departing form the true spirit of the invention, the scope of the invention being limited only by the appended claims as finally granted.

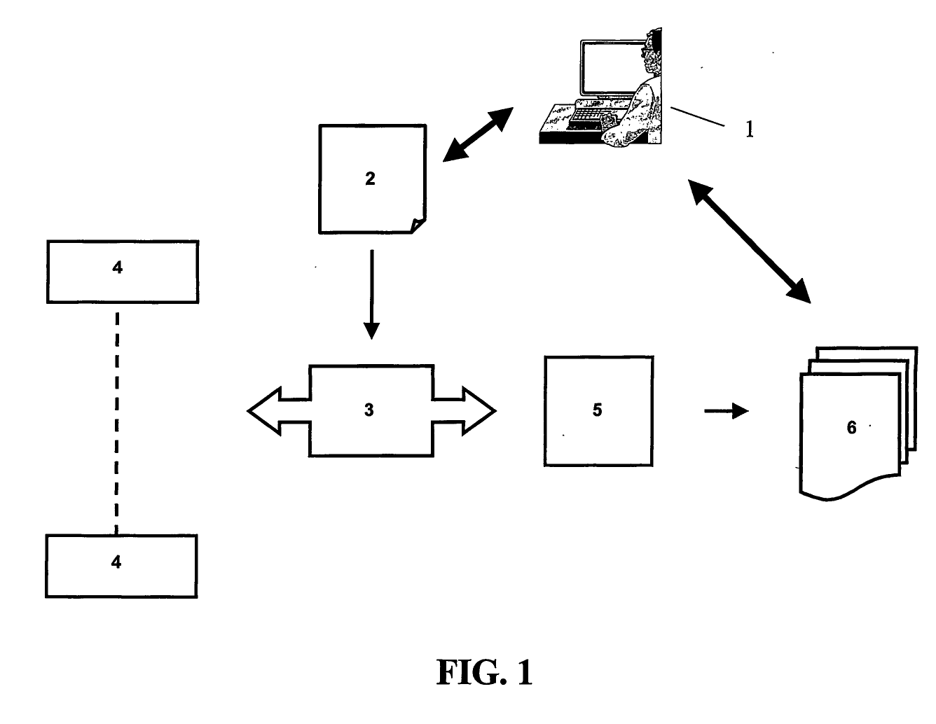

The invention is depicted schematically in FIG. 1, where a user (1) is person that performs the editing of a content (2). The user (1) is often called a content manager, or webmaster in the case of Internet related applications. The content (2) is in electronic quality, and can be XML content or any other content type or computer language such as, HTML, MPEG and other coded representations of visual and/or video-content.

The content (2) is meant to be represented to an end-user via an end-user device. Representation means that content (2) is not necessarily presented to the end-user in exactly the same form as it is available to user (1). End-user devices can be communications devices, such as mobile telephones and handsets. Since the there is an increasing number of end-user device types, one should take into account the differences between different types of devices used by end-users. Differences can be on different levels, such as the hardware level (screen size, colours, etc.), the software level (content-types support, JAVA support, DOJA support, etc.) and the user relevance level (pre-paid, postpaid, language of the end-user).

In addition, the qualities of different end-users can differ too. These differences have to be taken into account in order to achieve a proper representation of the content (2) to the end-user. As a consequence, there should be content (2) suitable for the each device type it should be displayed on. On the other hand it is preferred that the user (1) not manages different versions of the same content (2), i.e. for each end-user device a version of the content (2).

According to the invention, the user (1) can manage the content (2) without having to take into account the differences of the end-user devices for which the content (2) is intended for. The editing of the content (2) should therefore only be done once, instead of having multiple versions of content (2), i.e. one version for each end-user device. For this purpose, a translator function (3) is available for the user (2) that translates the input content (2) into a format of the content (2) that is suitable for being displayed on a specific end-user device. The translator function (3) has for this purpose available the specifications of the different types of end-user devices. The specifications are available to the translator function (3) by means of parameters (not depicted in FIG. 1) for each end-user device type that represent the characteristics of the devices.

The translator function (3) outputs a production content (4) that is suitable to be displayed, after it is communicated, on the end-user devices. For each type of end-user device there can be a separate production content (4). The production content (4) is in general of the same content type as content (2). The user (1) is able to edit content for different end-user device types, without having knowledge of these different end-user device types. It is even not necessary that the user (1) is aware of the existence of different end-user device types.

From FIG. 1 it can be seen that the translator function (3) outputs also to a processing function (5). The processing function (5) processes the output from the translator function (3) because the production content (4) is not suitable for being displayed on the device that is used by the user (1) to preview the results. The previewing using processing function (5) can be done before, during or after the production content (4) is being produced. In general, the preview device used by user (1) differs from the devices used by the end-users. For instance, a workstation computer screen is used by user (1) for previewing content while end-users use mobile phones. In this way the user (1) is able to see how the production content (4) would be presented on the different types of end-user devices. For this purpose, the processing function (5) generates preview content (6) and is provided with parameters that represent the characteristics of the different types of end-user devices and representing the characteristics of the preview means of the user (1).

Steps that may be part of the editing process can involve the provisioning of the parameters representing the characteristics of the end-user device types and the preview environment of user (1). Further, page lay-outs or template definitions, for instance for a menu or a page comprised by the content, may be used by the user (1) when editing content. Preferably but not necessarily different end-user device type use the same page lay-outs. After the end-user independent editing is done by the user (1), the content can be previewed taking into account the characteristics of the end-user device type. The production content (4) is then published, for instance on a web server, for each supported end-user device type. On basis of end-user device recognition (e.g. on basis of UserAgentString or on basis of CLI and a database) the right content is shown to the end-user when accessing the site.

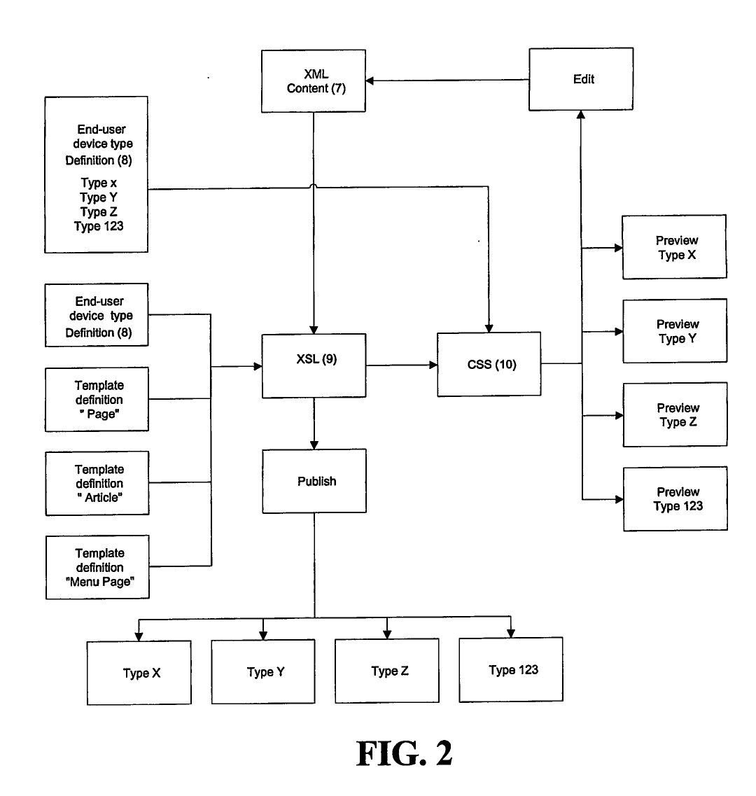

FIG. 2 shows an embodiment where XML content (7) is edited. XML stands for Extended Mark-up Language. The XML content is parsed via an XSL (9) style sheet to produce for instance HTML. XSL stands for extensible stylesheet language. XSL (9) acts in this process as a translation function (3). Parameters that represent characteristics of the different end-user types are comprised by a device type definition (8). There also may be one or more template definitions be inputted to XLS (9). The output of XLS (9) is the production content (4) that is suitable for the supported end-user device types. For previewing purposes, a cascading style sheet (10) is used. The cascading style sheet (10) is also provided with a device type definition (8) and outputs preview content (6) for the different supported end-user device types. As a result of this method, the preview content (6) is the same as the production content (4), and so the same as the content presented to the end-user.

1. Method for editing by a user (1) of content (2) to be represented via an end-user device to an end-user, using a translation function (3) that translates content (2) into production content (4) which translation function (3) makes use of characteristics of an end-user device type, resulting in production content (4) that is suitable for being presented via an end-user device of said type.

2. Method according to claim 1, whereby the characteristics of an end-user device type are represented by parameters that are available to the translation function (3).

3. Method according to claim 1, whereby the characteristics of an end-user device type are hardware related characteristics.

4. Method according to claim 1, whereby the characteristics of an end-user device type are software related characteristics.

5. Method according to claim 1, whereby the characteristics of an end-user device type are firmware related characteristics.

6. Method according to claim 1, whereby also characteristics of a user group are taken into account by the translation function (3).

7. Method according to claim 2, whereby the characteristics of an end-user device type relate to the screen comprised by the end-user device.

8. Method according to claim 1, whereby the content (2) is XML content.

9. Method according to claim 7, whereby the translation function (3) uses XSL style sheets.

10. Method according to claim 1, whereby the output of translation function (3) is processed for preview purposes by a processing function (5) that makes use of characteristics of an end-user device type resulting in preview content (6) that can be presented to the user (1) and which preview content (6) is representative for the production content (4) as would be presented to an end-user via an end-user device of said type.

11. Method according to claim 10, whereby the processing function (6) also makes use of characteristics of the preview means that are used by user (1).

12. Method according to claim 11, whereby the characteristics of the preview means are hardware related characteristics.

13. Method according to claim 12, whereby the hardware characteristics comprise the size of a screen that is used for preview purposes.
